(19) United States
(12) Patent Application Publication
(10) Pub. No.: US 2015/0349919 A1
(43) Pub. Date: Dec. 3, 2015

(54) RADIO DATA PACKETS

(71) Applicant: NORDIC SEMICONDUCTOR ASA, TRONDHEIM (NO)

(72) Inventors: DAVID ALEXANDRE ENGELIEN-LOPES, MALVIK (NO); SVERRE WICHLUND, TRONDHEIM (NO); PHIL CORBISHLEY, CHILTON (GB)

(73) Assignee: NORDIC SEMICONDUCTOR ASA, TRONDHEIM (NO)

(21) Appl. No.: 14/290,244

(22) Filed: May 29, 2014

(51) Int. Cl. H04L 1/00

(52) U.S. Cl. CPC H04L 1/0041; H04L 1/0061

(57) ABSTRACT

Radio transmission apparatus is configured to transmit binary message data in variable-length radio data packets. Each data packet comprises (i) a variable-length data unit and (ii) an error-detecting code for the data unit. The length of the error-detecting code varies between data packets according to a property of each data packet, such as the length of the data unit of the data packet, or a field in the data packet that specifies the length of the error-detecting code.

This application relates to communication using radio data packets.

Various short-range radio communication protocols are known in which binary message data is transmitted in data packets. In some protocols, the data packets are of fixed length, but greater flexibility and efficiency can be provided by protocols that support variable-length data packets. Examples of the latter protocols include Bluetooth™ and Bluetooth Low Energy™.

A radio data packet will often contain an error-detecting code, such as a cyclic redundancy check (CRC). This consists of a binary value that is derived from the data unit of the packet. It enables radio receiving apparatus to determine if there have been any transmission errors in a received data packet, within a certain confidence level. Some error-detecting codes may also be used to correct errors. The use of error-detecting codes is especially useful in radio communication, because there are many potential sources of transmission errors, including signal fading and interference from other radio transmitters.

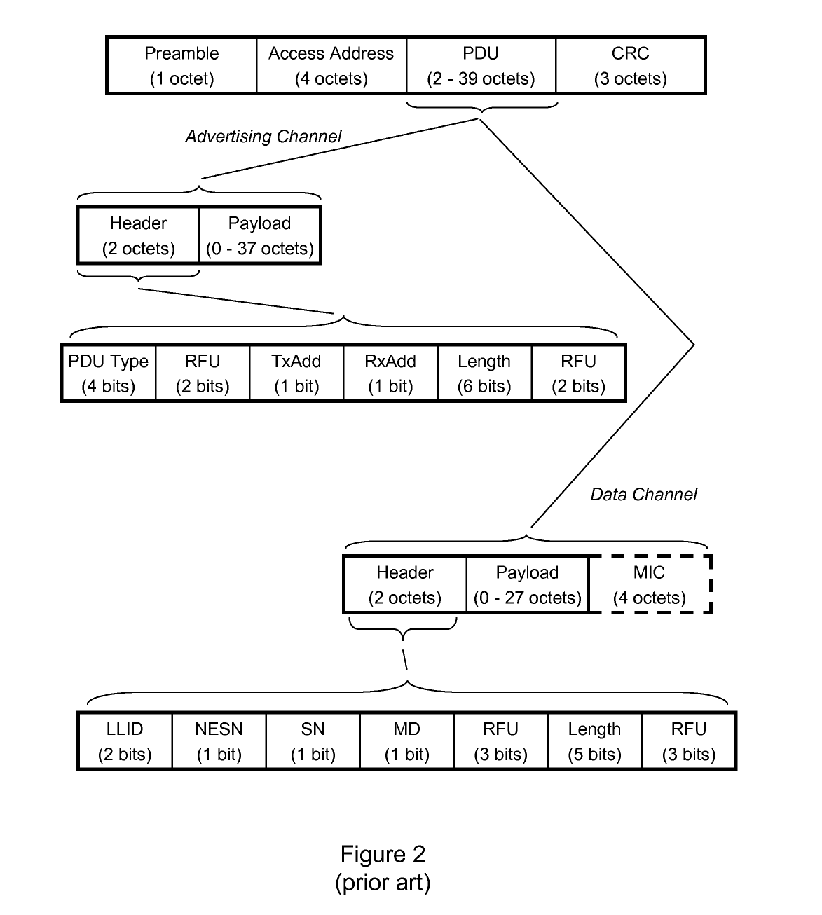

As an example, in the Bluetooth Low Energy™ specifications (e.g. Bluetooth™ Core Specification 4.0, published 30 Jun. 2010), a data packet has the format shown in FIG. 2: a 1-byte preamble, a 4-byte access address, a 2-byte header, a data unit of between zero and 37 bytes, an optional 4-byte message integrity check, and a 3-byte cyclic redundancy check (CRC), where a byte is 8 bits long. The header, payload and optional message integrity check are referred to as the protocol data unit (PDU). The CRC is calculated over the PDU, using a 24-bit polynomial of the form x²⁴+x¹⁰+x⁹+x⁶+x⁴+x³+x+x+1.

Short-range radio protocols are often used in energy-constrained applications, such as battery-powered sensors, for which a single lithium cell may be expected to last several years.

While protocols such as Bluetooth Low Energy™ are already well suited to energy-constrained applications, the present inventors have realised that even greater energy efficiency is possible.

From a first aspect, the invention provides radio transmission apparatus configured to transmit binary message data in variable-length radio data packets, wherein each data packet comprises (i) a variable-length data unit and (ii) an error-detecting code for the data unit, and wherein the length of the error-detecting code varies between data packets according to a property of each data packet.

From a second aspect, the invention provides a method of radio transmission, comprising transmitting binary message data from a radio transmitter in variable-length radio data packets, each data packet comprising (i) a variable-length data unit and (ii) an error-detecting code for the data unit, wherein the length of the error-detecting code varies between data packets according to a property of each data packet.

From a third aspect, the invention provides a system for radio communication, comprising a radio transmitter and a radio receiver, wherein the radio transmitter is configured to transmit binary message data in variable-length radio data packets, wherein each data packet comprises (i) a variable-length data unit and (ii) an error-detecting code for the data unit, wherein the length of the error-detecting code varies between data packets according to a property of each data packet, and wherein the radio receiver is configured to receive the variable-length radio data packets and to use the error-detecting codes of received data packets to determine whether the data units of the received data packets contain errors.

From a fourth aspect, the invention provides radio receiving apparatus configured to:
receive variable-length radio data packets, wherein each data packet comprises (i) a variable-length data unit and (ii) an error-detecting code for the data unit, and wherein the length of the error-detecting code varies between data packets according to a property of each data packet; and
use the error-detecting codes of received data packets to determine whether the data units of the received data packets contain errors.

Thus it will be seen by those skilled in the art that, in accordance with the invention, the length of the error-detecting codes can vary from one data packet to the next. This means that shorter codes can be used when circumstances allow, thereby saving power in the transmitter and the receiver, while longer codes can be used when a greater level of error-detecting ability is required. Because the length of the code is associated with a property of the data packet, the receiver can determine from the received packet what length of error-detecting code is contained in the packet. This can simplify decoding of the data packet.

The radio transmission apparatus may be configured to determine whether to transmit a relatively-short error-detecting code or whether to transmit a relatively-long error-detecting code in a data packet based on said property of the data packet (or on a value of said property). However, this is not essential, and the radio transmission apparatus may be configured to determine whether to transmit a relatively-short error-detecting code or whether to transmit a relatively-long error-detecting code in a data packet based on any appropriate factor or factors, and may be configured to control said property of the data packet (or a value of said property) to accord with the length of the error-detecting code that the radio transmission apparatus determines.

The property of the data packet may take any appropriate form.

In one set of the embodiments, the property is the length of the data unit. In this way, a short data packet can be kept even shorter by having a relatively-short error-detecting code, thus saving power in the transmitter and in the receiver, while larger packets (which are statistically more likely to experience transmission errors) can contain relatively-long error-detecting codes. This can allow a desired minimum level of error-detecting ability to be maintained across different packet sizes.

In another set of embodiments, the property is a field in the data packet that specifies or encodes the length of the error-detecting code. This enables the radio transmission apparatus to determine whether a longer or shorter error-detecting code is required for any given data packet, e.g. based on one or more criteria. It may make this determination based on the contents of the data packet, such as on the value of an importance level associated with message data in the packet contains, or on other factors, such as the quality of a radio link between the transmission apparatus and a receiver.

The code-length field may also be used by the transmitter and/or receiver for other purposes, or it may be used solely to specify or determine the length of the error-detecting code. It may comprise a value (e.g. a binary value) that equals the length of the code, e.g. in bits or bytes, or it may comprise any other information that specifies the length of the data unit, e.g. according to a predetermined encoding scheme. The receiving apparatus may read or decode the code-length field to determine the length of the code. This set of embodiments may overlap with the preceding set of embodiments, such that the length of the error-detecting codes of data packets may sometimes vary with the length of the data unit and sometimes as specified by a code-length field in the data packet (which may not necessarily be present in all data packets).

It will be appreciated that these examples of different properties of data packets are not exhaustive and that other properties may be used in some embodiments, as well as, or instead of, the properties mentioned in these examples.

In all embodiments, the data unit preferably contains a data payload comprising, or consisting of, binary message data. The data unit may also contain other components, such as a data-payload length field and/or a message integrity check. The data unit may consist of a series of contiguous bits within the data packet, or it may be distributed across two or more disjoint blocks or regions within the data packet. The data packet may also contain other components, in addition to the data unit, which are not included in the derivation of the error-detecting code. For instance, the data packets will typically contain a data-unit length field that specifies or encodes the length of the data unit.

In embodiments in which some or all data packets contain a code-length field, this field may be in the data unit (and hence included in the error-detecting code calculation) or it may located outside the data unit, such as in a general packet header. A value in a code-length field may be encoded in any appropriate way.

The error-detecting code is preferably calculated by the radio transmission apparatus. In preferred embodiments, the error-detecting code comprises a cycle-redundancy check (CRC). For instance, it may be a CRC around 3 or 4 bytes long. However, other codes, such as standard cryptographic hash functions, could be used instead. In some embodiments, the error-detecting code may comprise an error-correcting code.

The radio transmission apparatus may cause the length of the error-detecting code of a data packet to be equal to one of a predetermined set of different lengths; e.g. by generating a code having such a length, or by instructing a microprocessor to do so. The number of different lengths in this set may be two, three, four, ten, twenty or more. When the code length is determined by the length of the data unit, the number of different possible error-detecting code lengths need not equal the number of different lengths that the data unit may have; in fact, in preferred embodiments it is (substantially) smaller, to enable the data packets to be kept as short as possible. This is possible because each additional bit in an error-detecting code will typically increase the error-detecting power of the code by substantially more than the increased probability of errors that is cause by extending the data unit by one bit. Thus, in some preferred embodiments, the error-detecting code may have only two different lengths (e.g. 3 bytes long and 4 bytes long), even though the data unit may have a range of different possible bit-lengths (e.g. between about zero and about 30 or 40 bytes long, or between about zero and about 256 bytes long).

In embodiments in which the code length is determined by the length of the data unit, the radio transmission apparatus is preferably configured to determine whether the data unit of a data packet has a length that is greater than a threshold length. It is preferably configured to include in the data packet an error-detecting code having a first length if the data unit is less than or equal to the threshold length and to include in the data packet an error-detecting code having a second length, greater than the first length, if the data unit is greater than the threshold length.

References to lengths in this specification will typically be bit-lengths; however, the possibility of alternative numerical bases (e.g. hexadecimal lengths) in some embodiments is not excluded.

It will be appreciated that this length comparison determination, or similar operations, may be implemented in a variety of different ways. It could, for example, be implemented by determining whether the data-unit length is less than some value that is higher than the threshold, while still giving the same result. The radio transmission apparatus might be configured to compare the length of a variable-length portion of the data unit, such a data payload portion, with a predetermined value.

The radio transmission apparatus may determine the length of the error-correcting code based on the actual length of the data unit (or a portion thereof), or it may determine the length of the error-correcting code based on separate length data; for instance, based on the contents of a length field supplied with the payload data from a source beyond the radio transmission apparatus, or calculated previously by the radio transmission apparatus.

A threshold length may be fixed (e.g. determined by a value stored in a read-only memory), or it may be changeable; e.g. configurable by software code executing on the apparatus, or set by configuration data received from outside the apparatus, e.g. over a radio link.

In some embodiments, the radio transmission apparatus may be configured to transmit data packets having data units whose lengths lie within a predetermined range or set of lengths. A threshold length for determining the length of an error-correcting code may correspond approximately to a mid-point of the range or set, such that data packets comprising data units with lengths in approximately the lower half of the range of possible data-unit lengths will contain a relatively-short error-correcting code, while data packets comprising data units with lengths in approximately the upper half of the range or set of possible data-unit lengths will contain a relatively-long error-correcting code. The relatively-short error-correcting code may, in some preferred embodiments, be one byte shorter than the relatively-long error-correcting code; e.g. 3 bytes and 4 bytes respectively. A byte will typically be an octet (e.g. eight bits), although this is not essential; it may, in some embodiments, be 16 bits or 32 bits, for instance, depending on the architecture of the apparatus.

In one preferred set of embodiments, the radio transmission apparatus is configured to determine whether the most significant bit (binary digit) of length data associated with a data packet (e.g. a length field for a data payload in the data unit) is a zero or a one, and to include a relatively-short error-correcting code in the data packet if the bit is a zero, and a relatively-long error-correcting code if the bit is a one. The inventors have recognised this as a particularly computationally efficient way of implementing aspects of the present invention, which can allow for efficient use of time and processing power.

Of course, the radio transmission apparatus may be configured to determine whether the lengths of data units lie above or below two or more different thresholds, and to set the lengths of error-detecting codes for the respective data packets based on the outcomes of these determinations.

In all embodiments, the radio transmission apparatus will typically be configured to receive message data for transmission by radio from another component or apparatus, such as a microprocessor or other logic device. This source of message data may be integrated with the radio transmission apparatus, e.g. on a single silicon chip, or may be external to it. The message data may be received over a wired communications link such as a data bus or serial connection (e.g. SPI). The transmission apparatus may comprise, or be communicably connected to, one or more sensors, such as temperature sensor and/or a microprocessor or other logic device.

The radio transmission apparatus may be configured to determine the length of received message data and to generate a length field in the data packet based on this calculation.

The radio transmission apparatus is preferably configured to divide message data that is longer than a maximum data-unit length into two or more data units, which may be of equal or unequal lengths, and to transmit the data units in respective data packets, each data packet having a respective error-detecting code. One or more of such data packets may include a flag to indicate the presence of continued message data in a subsequent data packet; for example, a “More Data (MD)” bit as described in the Bluetooth Low Energy™ specifications.

The radio data packets are preferably all transmitted using a single, predetermined radio data protocol. In some preferred embodiments, this protocol substantially conforms to a Bluetooth Low Energy™ specification. It may, for instance, conform to a Bluetooth Low Energy™ specification, but with the length of the CRC field being variable, such as being either 3 bytes or 4 bytes. There may be a further difference in that the length of the data payload (and hence potentially also the length field) may be increased so as to support longer data packets than are currently permitted. For instance, the length field in a Data Channel PDU may be increased from 5 bits to 8 bits, with the length of a Data Channel payload then increasing to a maximum of around 256 bytes. This could be done by utilising some of the bits in the PDU Header that are currently Reserved for Future Use (RFU), or by allowing longer PDU Headers.

Some embodiments may implement a Bluetooth Low Energy™ specification further modified to allow for an additional field in the Header of the Data Channel protocol data unit (PDU) and/or the Advertising Channel PDU that can encode the length of the CRC field. This may be done by making use of existing RFU bits, or by allowing longer Headers. Alternatively, a CRC-length field could be included in a modified Bluetooth Low Energy™ data packet outside the PDU (e.g. adjacent to the Access Address).

The radio receiving apparatus is preferably configured to determine, from a received data packet, the property of the data packet according to which the length of the error-detecting code varies, and to calculate an expected length for the error-detecting code in the received data packet. In some embodiments this may involve determining the length of the received data unit in the data packet, or reading a value from a data-unit length field in the data packet; in other embodiments, it may involve reading a value from an error-detecting-code-length field in the data packet. The receiving apparatus may then use this expected code length when reading the error-detecting code from the data packet; e.g. to know how many bits or bytes to read from the data packet. It may use the expected code length to configure or select an error-detecting-code checking algorithm to use when processing the error-detecting code; for example, it may select a generator polynomial of degree corresponding to the expected length for decoding a received CRC.

The radio receiving apparatus is preferably configured to read message data from one or more received data packets, and to output the message data. The message data may be output to a microprocessor or other logic device. Such a microprocessor or other device may be integrated with the receiving apparatus, or may be separate therefrom (e.g. connected by a data bus or serial connection). In some embodiments, the receiving apparatus comprises, or is communicably connected to, output means such as a display or loudspeaker and/or a microprocessor or other logic device.

When the data packet contains an error-detecting-code-length field, this may contain a binary value equal to the length of the error-detecting code in the packet. However, the length may be encoded in any appropriate way. Some embodiments use a more efficient representation, which allows the packet to be shorter, thereby saving time and power. For instance, the code-length field may be two bits long; it may encode the length of the error-detecting code as one of four different lengths, such as 16, 24, 32 or 40 bits. The field may comprise a number of contiguous bits within the data packet, but it may be split across two or more sections of the data packet.

The radio transmission apparatus may determine information regarding the quality of a radio link with radio receiving apparatus, such as a packet failure rate for previously transmitted data packets (e.g. calculated over a predetermined number of earlier packets, or over a predetermined period of time). It may use this information (possibly in combination with other information) to determine what length error-detecting code to include in a data packet. A longer code may be used if the link is unreliable. This would allow a short code to be used if the link is very good, allowing greater throughput of data, or reduced power consumption. Although the reduction in packet length may be fairly modest, when communicating using relatively small packets such an approach may nevertheless lead to the reduction or removal of fragmentation and the need for re-assembly of received packets, providing a significant power saving.

In some embodiments, the error-detecting code may vary according to the length of the data unit for some data packets (e.g. packets containing no code-length field, or containing a code-length field with null contents), and may vary according to the value of a code-length field for other data packets (e.g. packets containing a code-length field with non-trivial contents). In this way, a radio transmitter may determine the code length based on data-unit length under a first set of conditions, but may override this and use a code length controlled directly by the transmitter (or by a microprocessor or other device that controls the transmitter), based on one or more other factors, under a second set of conditions (e.g. if the radio link is determined to be particularly strong or particularly weak). The transmission apparatus may set a relatively long code length when transmitting relatively important data, for which it would be unacceptable if a transmission error went undetected by the receiver (e.g. caused by an aliasing error), and a relatively short code length for relatively unimportant data. The transmission apparatus may receive an indication of the importance of message data from another component, such as a microprocessor (e.g. as a value of an “importance” parameter).

In any embodiment, the length of the error-detecting code field may be set so as to maintain a predetermined level, or minimum level, or error-detecting ability. When using a constant-length CRC, as is known in the prior art, the probability that a received data packet that contains errors is determined as being error-free will increase as the length of the data packet increases. However, certain embodiments of the present invention can exploit the fact that the aliasing probability (i.e. the probability of two random data units generating the same code) of a CRC is 2⁻ⁿ where n is the degree of the polynomial generator of the CRC. This means that using a longer CRC with longer data units allows the probability of missing errors in a data packet to be kept lower even as the length of the data unit increases.

The invention can be viewed from a number of different aspects.

From a further aspect, the invention provides a radio communication system comprising radio transmission apparatus as described herein and radio receiving apparatus as described herein.

From a further aspect, the invention provides a method of radio transmission, comprising transmitting binary message data from a radio transmitter in two or more radio data packets, each data packet comprising (i) a data unit and (ii) an error-detecting code for the data unit, wherein:
a property of a first one of the data packets has a first value;
the error-detecting code of the first data packet has a first length;
a second one of the data packets has a second value for the property, different from the first value; and
the error-detecting code of the second data packet has a second length, greater than the first error-detecting-code length.

From another aspect, the invention provides radio transmission apparatus configured to transmit binary message data in variable-length radio data packets, wherein each data packet comprises (i) a data unit, (ii) information encoding the length of the data unit, and (iii) an error-detecting code for the data unit, and wherein the length of the error-detecting code is determined by a property of the data packet.

From another aspect, the invention provides a method of radio transmission, comprising transmitting binary message data from a radio transmitter in variable-length radio data packets, each data packet comprising (i) a data unit, (ii) information encoding the length of the data unit, and (iii) an error-detecting code for the data unit, wherein the length of the error-detecting code is determined by a property of the data packet.

From another aspect, the invention provides a system for radio communication, comprising a radio transmitter and a radio receiver, wherein the radio transmitter is configured to transmit binary message data in variable-length radio data packets, wherein each data packet comprises (i) a data unit, (ii) information encoding the length of the data unit, and (iii) an error-detecting code for the data unit, wherein the length of the error-detecting code is determined by a property of the data packet, and wherein the radio receiver is configured to receive the variable-length radio data packets and to use the error-detecting codes of received data packets to determine whether the data units of the received data packets contain errors. From another aspect, the invention provides radio receiving apparatus configured to:
receive variable-length radio data packets, wherein each data packet comprises (i) a data unit, (ii) information encoding the length of the data unit, and (iii) an error-detecting code for the data unit, and wherein the length of the error-detecting code is determined by a property of the data packet; and
use the error-detecting codes of received data packets to determine whether the data units of the received data packets contain errors.

The information encoding the length of the data unit may comprise a numerical value (e.g. a binary value) that specifies the length of the data unit, e.g. in bits or bytes, or it may comprise any other information that specifies the length of the data unit, e.g. according to a predetermined encoding scheme. The receiving apparatus may read or decode the information to determine the length of the data unit.

From a further aspect, the invention extends to computer software, and a tangible medium or signal bearing the same, which, when executed on radio transmitter or radio receiver, causes the radio transmitter or radio receiver to act according to any aspect or embodiment described herein.

Features of any aspect or embodiment described herein may, wherever appropriate, be applied to any other aspect or embodiment described herein. Where reference is made to different embodiments or sets of embodiments, it should be understood that these are not necessarily distinct but may overlap.

Certain preferred embodiments of the invention will now be described, by way of example only, with reference to the accompanying drawings, in which:

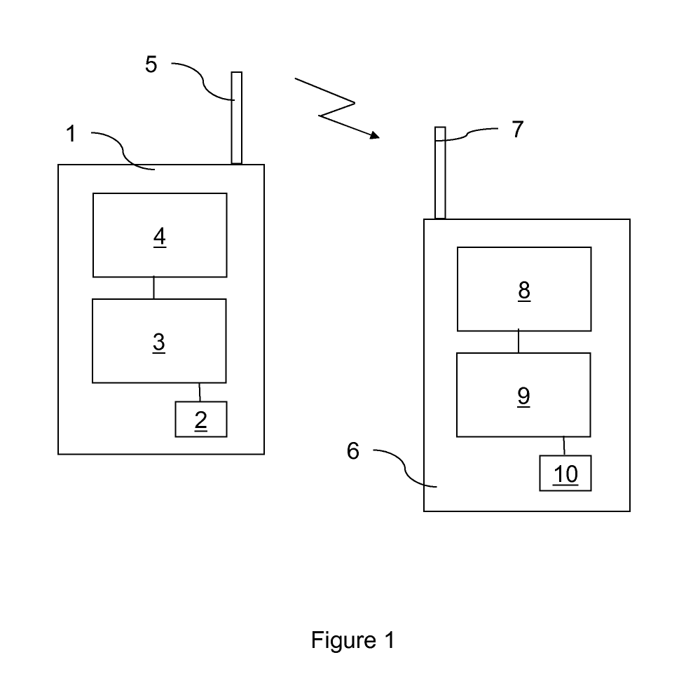

FIG. 1 is a schematic drawing of a radio communication system embodying the invention;

FIG. 2 is a diagram of a prior-art data packet;

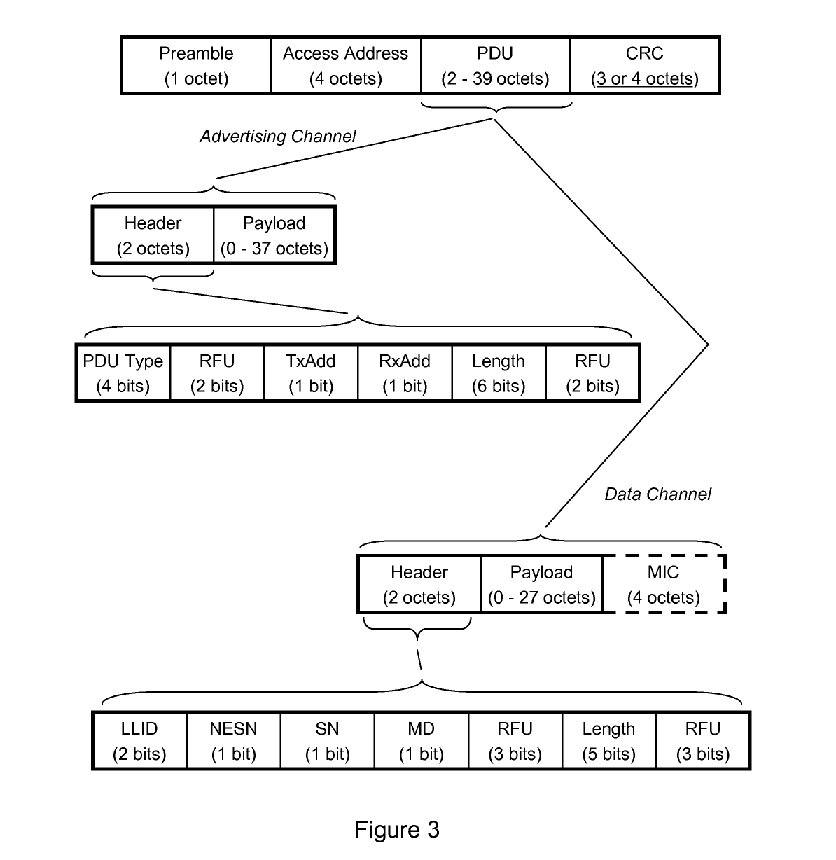

FIG. 3 is a diagram of a data packet transmitted in an embodiment of the invention; and

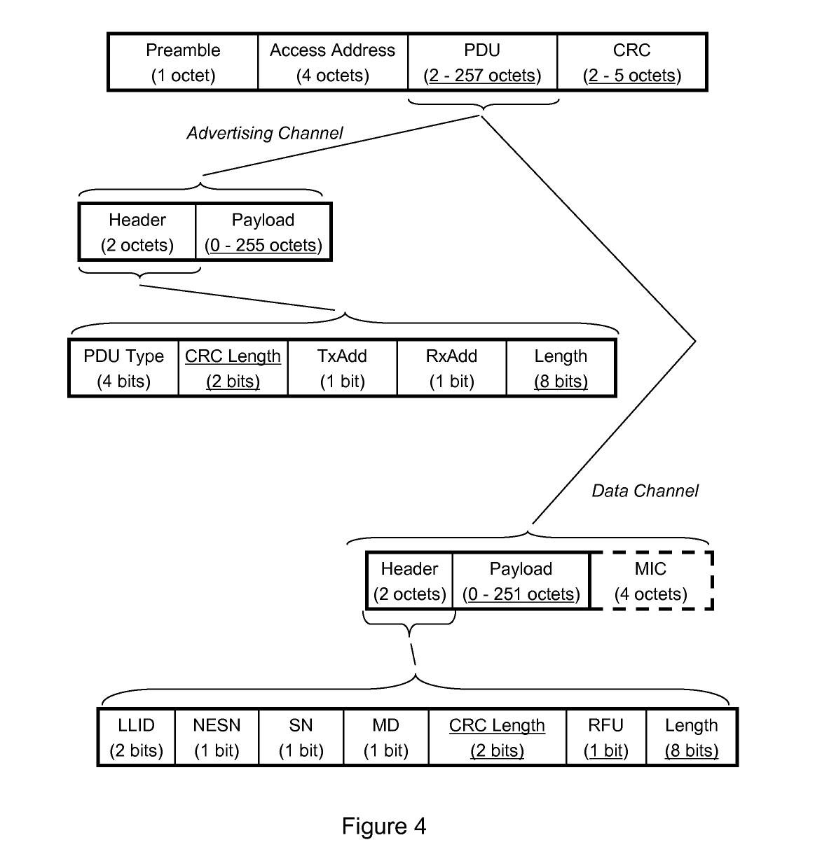

FIG. 4 is a diagram of a data packet transmitted in an alternative embodiment of the invention.

FIG. 1 shows a wireless heart-rate monitor 1 which is in communication with a mobile telephone 6, embodying the present invention.

The wireless heart-rate monitor 1 has a heart-rate sensor 2 which is connected to a microprocessor 3 (such as an ARM™ Cortex M-series). The microprocessor 3 is connected to a radio transmitter module 4. Other conventional components, such as memory, a battery, etc. are also present, but are omitted from the drawing for the sake of simplicity. The microprocessor 3 and radio transmitter module 4 may be integrated on a single silicon chip. The monitor 1 has a radio antenna 5, which may be integrated on such a chip or external to it.

The mobile telephone 6 has, among other conventional components (not shown), an antenna 7, suitable for receiving short-range radio communications from wireless-personal-area-network devices, which is connected to a radio receiver module 8. The radio receiver module 8 is connected to a microprocessor 9 (such as an ARM™ Cortex M-series), which can output data for display on a screen 10, possibly via other components, such as a further microprocessor (not shown) running an operating system and appropriate software applications.

In use, the wireless heart-rate monitor 1 receives periodic heart-rate readings for a human user from the heart-rate sensor 2. The microprocessor 3 processes the readings into a suitable format for transmission, and send the message data to the radio transmitter module 4. The radio transmitter module 4 determines whether the message data can fit within a single data packet, or if it must be split across two or more data packets. In either case, the radio transmitter module 4 assembles the data into a protocol data unit (PDU), with a corresponding length value in the header of the PDU, and calculates a CRC for the PDU. It assembles the PDU and CRC into a data packet and transmits the packet from the antenna 5.

The mobile telephone 6 receives the data packet (possibly containing transmission errors) at the antenna 7. The radio receiver module 8 extracts the PDU and the CRC and checks that the CRC corresponds to the PDU. If it does not match, it flags the packet as containing errors and may discard it or request retransmission from the wireless heart-rate monitor 1. If it does match, the data payload is extracted from the PDU and the message data is sent to the microprocessor 9 for processing. This may process it in any appropriate way. In some embodiments, the heart-rate may be displayed graphically on the display screen 10 for the user to see.

Apart from where specified to the contrary below, the wireless heart-rate monitor 1 and mobile telephone 6 are configured to transfer heart-rate message data from the wireless heart-rate monitor 1 to the mobile telephone 6 according to the Bluetooth Low Energy (BTLE)™ core specification version 4.0. The wireless heart-rate monitor 1 and mobile telephone 6 may be further equipped for two-way radio communication, although this is not essential.

FIG. 2 shows, for comparison purposes, the main elements of a conventional data packet according to the Bluetooth Low Energy™ core specification version 4.0. Data packets may be sent over an Advertising Channel or over a Data Channel. The high level structure of the data packets is the same on both channels: a preamble, followed by an access address, then a PDU of 2 to 39 octets length, and finally a 3 octet CRC field.

FIGS. 3 and 4 show modified data packets which the wireless heart-rate monitor 1 transmits in respective first and second embodiments. The main differences over the data packet of FIG. 1 are highlighted with underlining.

The data packet in FIG. 3 has a variable-length CRC field, which may be either 3 or 4 octets long. The radio transmitter module 4 of the wireless heart-rate monitor 1 determines whether to transmit a 3-octet CRC or a 4-octet CRC based on the length of the Payload. In some embodiments, a 3-octet CRC is transmitted when the most-significant bit of the Length field is a zero, and a 4-octet CRC is transmitted when it is a one.

The data packet in FIG. 4 also has a variable-length CRC field, of 2, 3, 4 or 5 octets. The PDU Header now contains a new 2-bit CRC Length field. A value of 00b corresponds to a 2-octet CRC; 01 b a 3-octet CRC; 10b a 4-octet CRC; and 11 b a 5-octet CRC. Other encodings are, of course, possible.

This data packet also supports longer data payloads than Bluetooth Low Energy™ core specification version 4.0, which can allow for more efficient data transfer.

In this embodiment, the microprocessor 3 or the radio transmitter module 4 of the wireless heart-rate monitor 1 determines whether to transmit a 2-, 3-, 4-, or 5-octet CRC based on any relevant factor or factors. This may include the length of the data payload. However it may also include a measure of the reliability of the radio link to the mobile telephone 6, which may be determined based on recent error rates.

On receiving a data packet as shown in FIG. 4, the radio received module 8 reads the CRC Length field of the PDU Header to determine how many CRC octets to expect. It then reads this many CRC octets from the data packet and checks that the CRC matches the received PDU, using a polynomial generator of the appropriate length.

In both embodiments, the radio communication can be optimised to reduce power drain on the wireless heart-rate monitor 1 while still preserving the ability to detect errors with reasonable confidence.

References herein to prior art do not constitute an admission that such publications form part of the common general knowledge in the art in any country of the world. The word “comprise”, and variants thereof such as “comprises” and “comprising”, as used in the present description and any accompanying claims, are used in an inclusive or open sense (i.e. so as not to preclude the presence or addition of further features), except where the context requires otherwise due to explicit language or necessary implication.

1. Radio transmission apparatus configured to transmit binary message data in variable-length radio data packets, wherein each data packet comprises (i) a variable-length data unit and (ii) an error-detecting code for the data unit, and wherein the length of the error-detecting code varies between data packets according to a property of each data packet.

2. Radio transmission apparatus as claimed in claim 1, wherein the property is the length of the data unit of the data packet.

3. Radio transmission apparatus as claimed in claim 1, wherein the property is a field in the data packet that specifies the length of the error-detecting code.

4. Radio transmission apparatus as claimed in claim 3, wherein the radio transmission apparatus is configured to determine whether a longer or a shorter error-detecting code is required for any given data packet based on the quality of a radio link between the radio transmission apparatus and radio receiving apparatus.

5. Radio transmission apparatus as claimed in claim 1, wherein the length of the error-detecting code varies according to the length of the data unit for some data packets and varies according to the value of a field in the data packet for other data packets, and wherein the radio transmission apparatus is configured to determine the length of an error-detecting code for a data packet based on the length of the data unit in the data packet under a first set of conditions, and to determine the length of an error-detecting code for another data packet based on one or more other factors under a second set of conditions.

6. Radio transmission apparatus as claimed in claim 1, wherein each data packet contains a data-unit length field that specifies the length of the data unit.

7. Radio transmission apparatus as claimed in claim 1, wherein the error-detecting code comprises a cycle-redundancy check.

8. Radio transmission apparatus as claimed in claim 1, configured to cause the length of the error-detecting code of a data packet to be equal to one of a predetermined set of different lengths.

9. Radio transmission apparatus as claimed in claim 8, wherein the number of different lengths in the predetermined set is smaller than the number of different lengths of data unit that the apparatus is configured to transmit.

10. Radio transmission apparatus as claimed in claim 8, wherein the number of different lengths in the predetermined set is two.

11. Radio transmission apparatus as claimed in claim 1, configured to determine whether the data unit of a data packet has a length that is greater than a threshold length, and to include in the data packet an error-detecting code having a first length if the data unit is less than or equal to the threshold length, and to include in the data packet an error-detecting code having a second length, greater than the first length, if the data unit is greater than the threshold length.

12. Radio transmission apparatus as claimed in claim 1, configured to determine whether the most significant binary digit of length data associated with a data packet is a zero or a one, and to include a relatively-short error-correcting code in the data packet if the digit is a zero, and a relatively-long error-correcting code if the digit is a one.

13. Radio receiving apparatus configured to:
receive variable-length radio data packets, wherein each data packet comprises (i) a variable-length data unit and (ii) an error-detecting code for the data unit, and wherein the length of the error-detecting code varies between data packets according to a property of each data packet; and
use the error-detecting codes of received data packets to determine whether the data units of the received data packets contain errors.

14. Radio receiving apparatus as claimed in claim 13, configured to determine, from a received data packet, said property of the data packet, and to calculate an expected length for the error-detecting code in the data packet.

15. Radio receiving apparatus as claimed in claim 14, configured to use the expected code length to configure or select an error-detecting-code checking algorithm to use when processing the error-detecting code of a received data packet.

16. Radio receiving apparatus as claimed in claim 13, wherein the property is the length of the data unit of the data packet, and wherein the radio receiving apparatus is configured to calculate an expected length for the error-detecting code from the length of the data unit in a received data packet.

17. Radio receiving apparatus as claimed in claim 13, wherein the property is a field in the data packet that specifies the length of the error-detecting code, and wherein the radio receiving apparatus is configured to calculate an expected length for the error-detecting code from said field in a received data packet.

18. A method of radio transmission, comprising transmitting binary message data from a radio transmitter in variable-length radio data packets, each data packet comprising (i) a variable-length data unit and (ii) an error-detecting code for the data unit, wherein the length of the error-detecting code varies between data packets according to a property of each data packet.

19. A method as claimed in claim 18, wherein the property is the length of the data unit of the data packet.

20. A method as claimed in claim 18, wherein the property is a field in the data packet that specifies the length of the error-detecting code.

21. A method as claimed in claim 20, comprising determining whether a longer or a shorter error-detecting code is required for any given data packet based on the quality of a radio link between the radio transmission apparatus and radio receiving apparatus.

22. A method as claimed in claim 18, wherein each data packet contains a data-unit length field that specifies the length of the data unit.

23. A method as claimed in claim 18, wherein the error-detecting code comprises a cycle-redundancy check.

24. A method as claimed in claim 18, comprising generating the error-detecting code of a data packet so as to have a length equal to one of a predetermined set of different lengths.

25. A method as claimed in claim 24, wherein the number of different lengths in the predetermined set is two.

26. A method as claimed in claim 18, comprising determining whether the data unit of a data packet has a length that is greater than a threshold length, and including in the data packet an error-detecting code having a first length if the data unit is less than or equal to the threshold length, and including in the data packet an error-detecting code having a second length, greater than the first length, if the data unit is greater than the threshold length.

27. A method as claimed in claim 18, comprising determining whether the most significant binary digit of length data associated with a data packet is a zero or a one, and including a relatively-short error-correcting code in the data packet if the digit is a zero, and a relatively-long error-correcting code if the digit is a one.

28. A system for radio communication, comprising a radio transmitter and a radio receiver, wherein the radio transmitter is configured to transmit binary message data in variable-length radio data packets, wherein each data packet comprises (i) a variable-length data unit and (ii) an error-detecting code for the data unit, wherein the length of the error-detecting code varies between data packets according to a property of each data packet, and wherein the radio receiver is configured to receive the variable-length radio data packets and to use the error-detecting codes of received data packets to determine whether the data units of the received data packets contain errors.
